(19) United States
(12) Patent Application Publication
(10) Pub. No.: US 2007/0156913 A1
(43) Pub. Date: Jul. 5, 2007

(54) Method for enabling extension points through plug-ins

(76) Inventors: Hiroyuki Miyamoto, Lexington, MA (US); Sami M. Shalabi, Winchester, MA (US)

Correspondence Address: THELEN REID BROWN RAYSMAN & STEINER LLP, 900 THIRD AVENUE, NEW YORK, NY, 10022, US

(21) Appl. No.: 11/322,670

(22) Filed: Dec. 30, 2005

(51) Int. Cl. G06F 15/16

(52) U.S. Cl. 709/230

(57) ABSTRACT

Methods and software are described which provide the ability to use plug-ins to extend functionality for J2EE applications. The methods involve use of an application deployment package including a plug-in manifest file containing plug-in meta-data, a unique identifier for the plug-in and interconnection data representing interconnections to other plug-in packages. An extension registry service uses the plug-in package to provide extensibility to the application by locating plug-ins and determining the interconnections between them based on the interconnection data. The extension registry service collects plug-in packages dynamically as J2EE modules are loaded by the J2EE platform and maintains the unique identifiers for all extension point(s) and extension(s) defined in the plug-in packages. The extension registry is used to find the associated extensions when the application executes an extension point. Identified extensions can then be invoked by extension point code.

### COPYRIGHT AND LEGAL NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND OF THE INVENTION

The present invention relates generally to software for extending functionality of applications. More particularly, the present invention provides plug-in software and methodologies for applications in a J2EE platform to provide extensibility easily and effectively.

A plug-in generally refers to a software module or other instruction code that adds a specific function or service to an application or operating system running on a computer system or platform. Plug-ins are useful in extending the functionality of the service or application. Computing environments or platforms provide varying levels of support for plug-ins. A computing platform is considered extensible if it provides a way to install or deploy an executable module such as a plug-in on a computer running the specific computing platform or environment.

An example of a computing platform is the Java 2 Enterprise Edition (J2EE) platform. J2EE defines a standard for developing enterprise applications that are portable and scalable and integrate with legacy applications operating in an enterprise. J2EE simplifies application building through the use of Application Programming Interface (API) layers. The Java Runtime Environment (JRE) in J2EE provides the libraries, the Java Virtual Machine (JVM), and other components to run applications written in the Java programming language. The libraries may include such APIs as: JNDI, RMI, RMI/IIOP, JTA, JTS, JMS, JSP, and Servlet API.

A Java application is typically packaged inside a Java Archive (JAR) file. A JAR file typically contains many class files, deployment descriptor, image, and any other files for a Java application gathered into a single file and, optionally, compressed. Each of the many class files typically consists of a collection of variables and methods or objects to run the application. A class further describes the rules by which objects behave; these objects are referred to as “instances” of that class.

A deployment descriptor is typically an XML-based text file whose elements describe how to assemble and deploy the unit into a specific environment. Deployment descriptor elements contain behavioral information about components not included directly in code. Their purpose is to tell the deployment tool how to deploy an application. A deployment descriptor could contain some security role mappings, transaction container information, and other components which are used at runtime.

The process of deploying an application into a J2EE platform typically consists of developing application Java code, packaging it into a deployment vehicle (e.g., JAR, an Enterprise ARchive (EAR), or a Web ARchive (WAR)) with appropriate metadata and any other resources that the application needs, and then deploying the J2EE application into the J2EE platform. Multiple JAR files themselves may be placed in an EAR. An EAR file is the same format as the JAR file, however it uses a directory called META-INF which contains deployment metadata files that describe the application. To deploy J2EE Web modules, a WebARchive (WAR) file is used instead of JAR. The WAR file is the same format as a JAR file, however it uses a directory called WEB-INF. The deployable JAR, EAR or WAR file is deployed to the J2EE environment. Deployment is typically done through platform-provided deployment tools which uses the deployment descriptor file located within a JAR, EAR or WAR file.

J2EE applications can be implemented to be extensible so they can take plug-ins for additional or altered functionality. However, the J2EE specification provides no help for implementing such extensibility in an application. The J2EE specification only defines how application modules are to be deployed and how they are managed on a server. In order to replace a function or behavior of a plug-in module in the J2EE platform, it has to be completely replaced via the deployment process discussed above. The application has to be stopped, modified, recompiled and redeployed.

In contrast, the functionality for easy extensibility is available in an Eclipse environment. Eclipse is an open source community which provides an integrated development environment for the development of platform and application frameworks used for building software. In the Eclipse model, a plug-in may be related to another plug-in by one of two relationships. In a dependency relationship, the roles are dependent plug-in and prerequisite plug-in, with a prerequisite plug-in supporting the functions of a dependent plug-in. In an extension relationship, the roles are host plug-in and extender plug-in, with the extender plug-in extending the functions of a host plug-in.

What is needed is an architecture for J2EE applications which allows new functional modules to be added or an existing functional module to be easily replaced without having to redeploy the J2EE application.

### BRIEF SUMMARY OF THE INVENTION

The present invention addresses the above-mentioned and other limitations of the background art by providing, among other things, a dynamic extensible system. This specification describes how such a dynamic extensible system can be obtained by exposing points in an application where extensions can be added in a real-time. An advantage of the extensible system described herein is that it can be easily and rapidly implemented. Once these exposed extension points are set up in an application, extra functionality can be added at runtime.

In accordance with an embodiment of the present invention, a method is provided for enabling an extension to an application in a J2EE environment through the use of the Eclipse-style plug-in mechanism. The extensible application deployment package comprises a plug-in manifest file containing plug-in meta-data which is placed into a certain subdirectory, based on the package type, e.g., JAR, WAR, etc. The plug-in manifest further comprises a unique identifier for the plug-in and interconnection data representing interconnections to other plug-in packages. The unique identifiers are required for plug-ins and extension points.

In accordance with an embodiment of the present invention, the plug-in package and an extension registry service are used to provide extensibility to the application by locating plug-ins—applications with a plug-in manifest file—and determining the interconnections between them based on the interconnection data. The extension registry service collects plug-in packages dynamically as J2EE modules are loaded by the J2EE platform and maintains the unique identifiers for all extension point(s) and extension(s) defined in the plug-in packages. The extension registry is used to find the associated extensions when the application executes an extension point. Identified extensions can then be invoked by extension point code.

Thus, according to some embodiments of the invention, a J2EE application can define its extension points and find the associated extensions dynamically at runtime and extended functionality may be added at runtime without disruption to the application or those using the application.

The foregoing, and a better understanding of the present inventions, will become apparent from the following detailed description of example embodiments and the claims when read in connection with the accompanying drawings, all forming a part of the disclosure of these inventions. While the foregoing and following written and illustrated disclosure focuses on example embodiments of the inventions, one should clearly understand that the example embodiments are illustrations and examples only and that the inventions are not limited thereto.

### BRIEF DESCRIPTION OF THE DRAWINGS

The invention is illustrated in the figures of the accompanying drawings, which are meant to be exemplary and not limiting, and in which like references are intended to refer to like or corresponding parts, and in which:

FIG. 1 is a block diagram of a computer system for describing plug-ins in accordance with an embodiment of the present invention;

FIG. 2 is a block diagram of a computer system illustrating the discovery and maintenance of plug-in components in accordance with an embodiment of the present invention;

FIG. 3 is a flowchart illustrating steps involved in the discovery and maintenance of plug-in components according to an embodiment of the present invention; and

FIG. 4 is a block diagram of a computer system, including software modules, illustrating the execution of plug-in functions in accordance with an embodiment of the present invention.

### DETAILED DESCRIPTION OF PREFERRED EMBODIMENTS

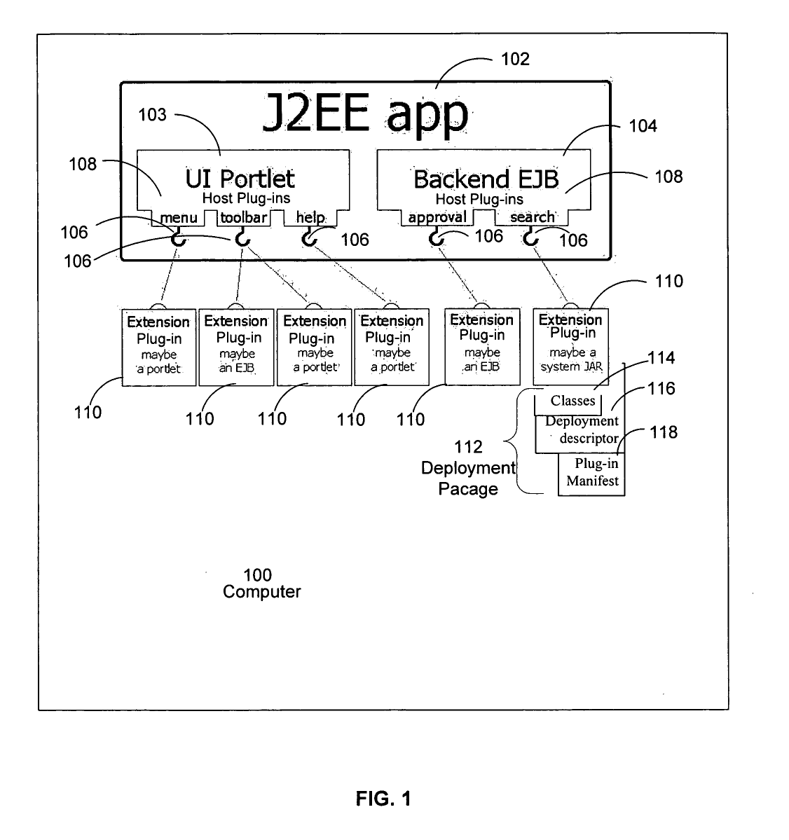

Embodiments of the present invention will now be described with reference to the drawings in the Figures. FIG. 1 illustrates an example of a J2EE application 102 executing on a J2EE platform 100 that has a User Interface (UI) Portlet 103 and Backend Enterprise JavaBeans (EJB) 104. The computer and components illustrated in FIG. 1 may be any type of computer system, including servers, appliances, etc., that runs a J2EE platform. The UI Portlet 103 and Backend EJB 104 each have one or more hooks 106 for plug-ins 110 and supplemental information 108. By creating hooks 106 that are in well-defined places in the application, plug-ins 110 can contribute functionality, thereby providing an extensible structure for the application. Plug-ins that have hooks are referred to herein as “host” or “extensible applications,” and plug-ins that are hooked or plugged in are referred to herein as “extenders” or “extensions.” Thus, UI Portlet 103 and Backend EJB 104 are host plug-ins, while plug-ins 110 that can connect to the hooks 106 are extensions or extenders.

Plug-ins are generally coded in Java. A typical plug-in consists of Java code in a JAR library, some read-only files, and other resources such as images, web templates, message catalogs, etc. Some plug-ins do not contain code at all. One such example is a plug-in that contributes online help in the form of HTML pages. For instance, some web portal applications require an extension capability for either functionality or service, and a plug-in is capable of providing that extension capability to an application 102.

Plug-in 110 provides added or modified functionality or service to the application 102. Plug-in 110 can be provided in a system JAR, an Enterprise Java Bean (EJB JAR), or a web module (WAR), and be deployed via the J2EE module deployment tools. For instance, the plug-in architecture, through the use of well-defined extension points, provides the ability to add new functionality to the web interface of the web portal applications 102 without needing to understand the specifics of the web portal application 102 at runtime.

Plug-in 110 is generally deployed into or removed from the J2EE platform 100 using a deployment tool, which is not shown. Deploying a plug-in involves copying the resources that constitute the plug-in, referred to herein as a deployment package 112, into the J2EE platform 100 that will run the plug-in. A single plug-in's deployment package 112 after being deployed is typically located together in a directory in the file system, or may be in multiple directories in the file system of a computer 100.

In some embodiments, a plug-in's deployment package 112 is a J2EE module generally containing necessary classes 114, deployment descriptors 116, and a plug-in manifest file 118. The classes 114, deployment descriptors 116 and manifest file 118 may be in one J2EE module or in separate modules. A class 112 represents code to be executed. In Java, a class will usually have its code contained in a “.class” file. As discussed above, a deployment descriptor 114 is generally an XML-based text file whose elements describe how to assemble and deploy the unit into a specific environment.

A plug-in typically describes how it provides capabilities and uses other plug-ins' capabilities through the plug-in manifest file 118. In one embodiment, the plug-in manifest file contains at least an identifier which identifies the plug-in and which is unique within a given system. The manifest file 118 further contains interconnection data used by an extension registry service (not shown) at runtime to determine what extension point(s) and/or extension(s) the plug-in defines.

In a J2EE environment, standardization is achieved by naming the manifest file 118 as the Eclipse open source programming environment (discussed above) does, that is, plugin.xml. In some embodiments, the plugin.xml file for the J2EE environment could employ the same format, syntax and same keywords as found in an Eclipse environment. Because the J2EE platform would only use a subset of an Eclipse's plugin.xml, developers of those extension points and extensions can use all the tools that are available for Eclipse Plug-in Development Environment. An example of “plugin.xml” file can be found in Appendix A.

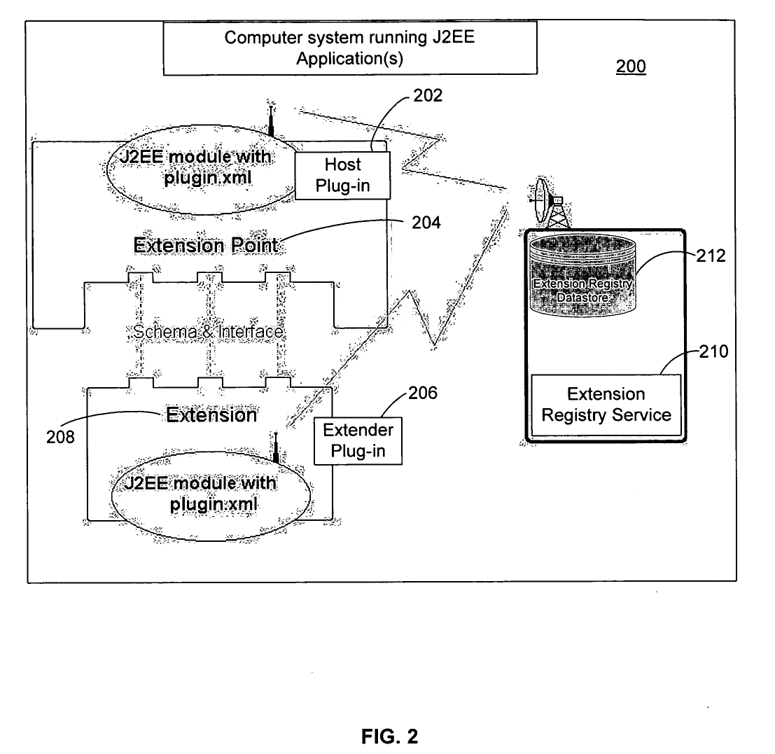

FIG. 2 illustrates an example of a computer system 200 executing one or more J2EE applications which use an extension registry service 210 to maintain associations between all the plug-ins of the application(s) as they are activated. The manifest file 118 (FIG. 1) is typically discovered and used by the extension registry service 210. In this embodiment, an association is maintained with a plug-in 206 that provides an extension 208 for the extension point 204. The host plug-in 202 and extender plug-in 206 may or may not be running within the same application. The host plug-in 202 and the extender plug-in are located by the extension registry service 210 through their plug-in manifest files. The extension registry service 210 then determines the associations between the plug-ins 202, 206 and adds their extension points 204 and/or extensions 208 in the registry datastore 212.

An extensible computer platform must host the infrastructure necessary to support the activation and registration of plug-ins. In one embodiment of the invention, this includes maintaining an extension registry datastore 212 of installed plug-ins and the function(s) they provide through an extension registry service 210. The extension registry service may also make use of a Java Naming and Directory Interface (JNDI) API. JNDI is an API that is part of the Java platform, providing applications based on Java technology with a unified interface to multiple naming and directory services. Using JNDI, applications based on Java technology usually store and retrieve named Java objects of any type. In addition, JNDI provides methods for performing standard directory operations, such as associating attributes with objects and searching for objects using their attributes.

A plug-in 202 that has an extension point 204 may also be known as a host plug-in 202 or a host role 202. A host plug-in acts as the coordinator and controller of one or more extensions. A plug-in 206 that has an extension 208 may also be known as an extender plug-in 206 or extender role 206. In another embodiment, host plug-in 202 may also incorporate an extension 208 in the same host plug-in 202. Alternatively, there may be many extender plug-ins 206 with extensions 208 for one extension point 204.

In the context of a particular extension 208, a plug-in that stands in the extender role 206 defines the extension 208, typically making certain aspects of itself available to a host plug-in 202 through the extension 208, and, in addition, causing the host plug-in 202 to add certain processing elements to its environment. An extension 208, therefore, is defined by an extender plug-in 206 and adds additional functionality that a host plug-in 202 did not originally have.

Extension points 204 are typically well-defined places in an application executing on a computer 200 where plug-ins can contribute functionality. For example, adding new menu items, extending existing choices, and adding pre- or post-processing to an existing task could all be potentially deployed as extension points 204. An existing application can thus be customized with extensions 208 at any time by any author by associating the extension 208 to the extension point 204 and deploying the extender plug-in 206 to the system 200.

An extension point 204 declaration in a host plug-in 202 typically includes specification of a specific XML schema for that extension point 204. Extensions 208 that are contributors to that extension point 204 need to be associated with that extension point 204. Therefore extensions 208 may do so by providing XML fragments containing data in a format that conforms to the schema defined by the extension point 204. In some embodiments, the data supplied by the extender plug-in 206 may be validated that it is well formed XML but may not be validated against the schema.

Host plug-ins 202 with extension points 204 may declare their functionality in the plug-in deployment descriptor 116 (FIG. 1), which is dynamically collected and made available to other plug-ins. One plug-in 202 may contain both extension point 204 and extension 208.

Extensions 208 need to be associated with at least one extension point 204 in order to be useful. The ability to define extension points 204 allows an application 200 to be flexible such that extensions 208 to extension points 204 can be added, removed, and updated with minimal impact to the platform as a whole since dependencies between functional components are clearly mapped by the extension-extension point relationship.

The plug-in manifest files 118 (FIG. 1) identify the host plug-in's 202 extension points 204 and extender plug-in's 206 extensions 208 by their unique IDs within a name space. Alternatively, the plugin.xml provides a unique ID for the extender plug-in 206 but not for the extension 208, and the extension registry service generates a unique ID for the extension when it becomes required. The extension registry service 210 can keep track of the relationship between every extension point 204 and its associated extensions 208 by their IDs. In one embodiment, the registry service deals solely with this type of metadata until the actual code is called for during runtime via a method invocation, for example, an extension 208 is selected for execution from a specific extension point 204 of host plug-in 202. As discussed earlier, the host plug-in 202 and extender plug-in 206 provide XML fragments to the extension registry service 210 containing data in a format that the extension registry service is programmed to understand, such as the format that Eclipse defines. In essence, the plug-in manifest file acts as the “protocol” used to register extension points 204 and extensions 208 to the runtime registry datastore 212 maintained by the extension registry service 210.

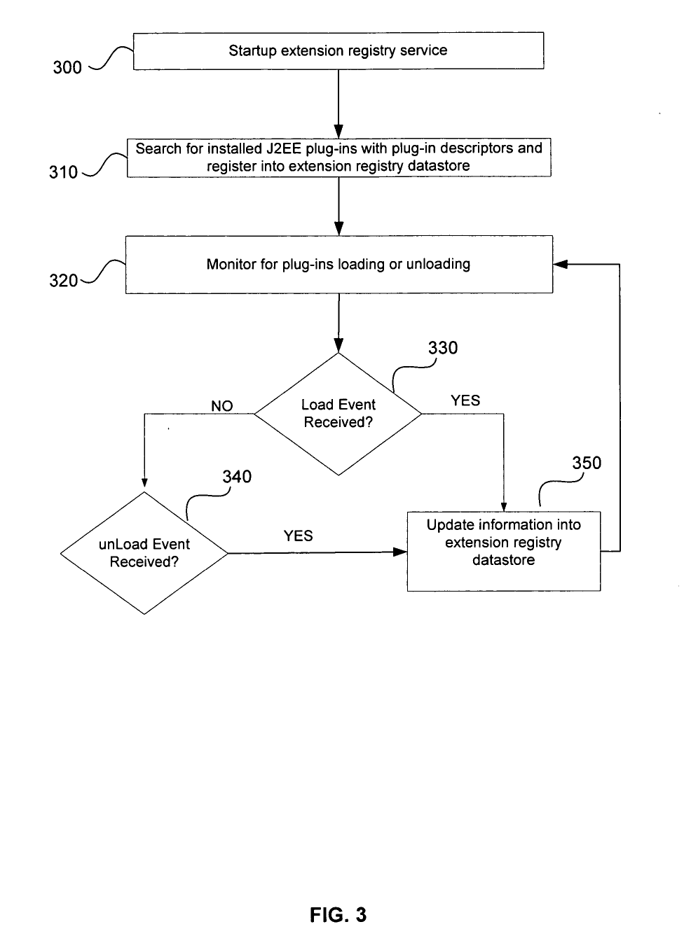

FIG. 3 illustrates an implementation for discovering and maintaining linkages between plug-in modules through an extension registry service implementation. At step 300, the extension registry service is started on platform startup. At step 310, the extension registry service searches the computer, and discovers and parses the contents of the plug-in descriptors from installed modules. However, statically found plug-ins are not enabled until the containing application gets started. Alternatively, the extension registry service 220 can dynamically collect (step 310) host plug-ins 202 and extender plug-ins 204 as their container J2EE modules are loaded (step 310) by the computer. In the implementation in IBM's WebSphere, plug-ins are solely collected through their load events.

At step 320, the extension registry service continues to monitor any module load and unload (e.g. starting and stopping of applications) on the computer. For instance, an implementation may have the extension registry service register itself as a module event listener such as WebSphere's MetaDataListener. The registry service will then be notified of each module load (step 320) and unload. The module load may be an occurrence of a new function being instantiated or an existing module having been modified.

At step 330, the extension registry service has registered itself as a module event listener in this illustration and is monitoring for a module load (step 320) event to occur on the computer. A module loading then passes information to the extension registry service. In this example, the passed-in argument (module event) should get the ClassLoader instance that is used for loading the module. A class loader is generally an object that is responsible for loading classes. Given the name of a class, a class loader should attempt to locate or generate data that constitutes a definition for the class. Saving this ClassLoader instance along with the plug-in it loads is essential to support lazy instantiation and method invocation later when an extension point needs to call its associated extensions. In lazy instantiation a program refrains from creating certain resources until the resource is first needed, thereby freeing valuable memory space.

Therefore, in some embodiments, the class loader instance that loads a plug-in is kept associated with the extension registry service so it can be used to instantiate the extension object later as and when needed. To work around the current classloader limitation typically found in a J2EE environment, the Host-defined interface 450 that an extension point defines and the extensions that provide implementation of that interface should be provided in a shared location in the system. When an extension is invoked, even if it is a newly deployed one, the class loader will be able to find it based on the association maintained by the extension registry service.

At step 340, the extension registry service “listens” for any application that has ceased execution, indicating the stopping of that application. In this example, a module event listener would be notified of every module unload for an application stop and take any necessary steps based on the application unloading, e.g., freeing up memory space. At step 350, the extension registry service updates the extension registry datastore to reflect whatever activity has been acted upon. More specifically, plug-in information is either added or removed, depending on the event, and all other affected plug-in information is updated based on the newly created associations or the now-obsolete ones.

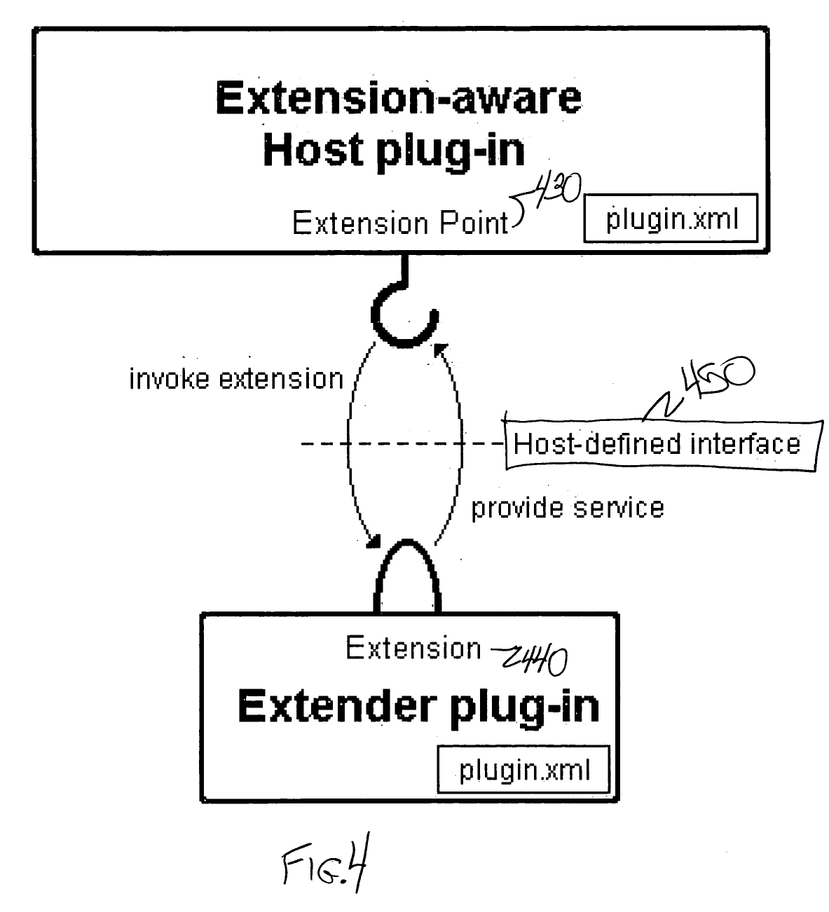

Once a plug-in has been deployed and registered, as discussed above, that plug-in can then be activated by the computer at runtime. FIG. 4 illustrates an example of a runtime application invoking an extension to activate plug-in functionality. The extension registry service, discussed previously, keeps track of the relationship between every extension point 430 and its associated extensions 440 by their IDs. A class loader is generally an object that is responsible for loading classes. Given the name of a class, a class loader should attempt to locate or generate data that constitutes a definition for the class. If the ClassLoader instance has been stored along with the plug-in it loads, the extension registry service should be able to support lazy instantiation and method invocation later when an extension point needs to call its associated extensions.

Examples of having an extension point 430 executed may be an application with an extension-aware pulldown menu about to be opened or that an extension-aware action bar is asked to render itself. The list of extension objects returned are used to implement the interface that the respective extension point 430 defines. The interaction between an extension point 430 and its extensions 440 can range from simply returning a text to a complicated multi-phase interaction.

For instance, in one embodiment, a context sensitive menu in an application is extension aware. Whenever the extension point 430 of the extension-aware menu is pulled down, the extension point 430 goes through all the associated extensions 440 for that menu, passing the context information to the menu for each menu item so that the individual menu items can determine how it should be displayed. The menu container calls each extension 440 one by one, collects menu items to include, and finally shows the menu. Then the user selects one of the menu items, and the event comes back to the menu container for further dispatch to the extension module 440, and the requested action is performed.

In another embodiment, a scheduler for background tasks defines an extension point 430 and an interface called IScheduler. This allows the scheduler to obtain the information about how often a task should be executed, at what time, on what day, etc. The interface includes methods such as start( ) and stop( ), so that tasks can be started and stopped according to the task-defined schedule. The scheduler itself can be implemented as a daemon process within the J2EE environment. This allows individual tasks to schedule their own execution by being an extension 440 to the scheduler extension point 430 and implementing the IScheduler interface methods. The extensions 440 then just wait for their start( ) and stop( ) methods getting called in accordance with the schedule, instead of implementing the schedule management by itself.

While the invention has been described and illustrated in connection with preferred embodiments, many variations and modifications as will be evident to those skilled in this art may be made without departing from the scope of the invention, and the invention is thus not to be limited to the precise details of methodology or construction set forth above as such variations and modifications are intended to be included within the scope of the invention. Except to the extent necessary or inherent in the processes themselves, no particular order to steps or stages of methods or processes described in this disclosure, including the Figures, is implied. In some cases the order of process steps may be varied without changing the purpose, effect or import of the methods described.

### APPENDIX A—MANIFEST EXAMPLE

1. Production Rules

The manifest markup definitions below make use of various naming tokens and identifiers. To eliminate ambiguity, the following are productions rules for these naming conventions. In general, all identifiers are case-sensitive.

SimpleToken := sequence of characters from (‘a-z’,‘A-Z’,‘0-9’,‘_’)
ComposedToken := SimpleToken | (SimpleToken ‘.’ ComposedToken)
PlugInId := ComposedToken
PlugInPrereq := PlugInId
ExtensionId := SimpleToken
ExtensionPointId := SimpleToken
ExtensionPointReference := ExtensionPointId | (PlugInId ‘.’
ExtensionPointId)

2. Plug-in Manifest DTD

The entire plug-in manifest DTD is as follows. However, each element of this DTD is explained in detail in the following subsections. XML Schema could not be used to define the manifest since the current Eclipse tooling for plug-in's requires a DTD. The XML DTD construction rule element* means zero or more occurrences of the element; element? means zero or one occurrence of the element; and element+means one or more occurrences of the element.

<?xml encoding=“US-ASCII”?>
<!ELEMENT plugin (requires?, extension-point*, extension*)>
<!ATTLIST plugin

| | |
|---|---|
| name | CDATA #IMPLIED |
| id | CDATA #REQUIRED |
| version | CDATA #REQUIRED |
| provider-name | CDATA #IMPLIED |

>
<!ELEMENT requires (import+)>
<!ELEMENT import EMPTY>
<!ATTLIST import

| | |
|---|---|
| plugin | CDATA #REQUIRED |
| version | CDATA #IMPLIED |
| match | (exact \| compatible \| greaterOrEqual) #IMPLIED |

>
<!ELEMENT extension-point EMPTY>
<!ATTLIST extension-point

| | |
|---|---|
| name | CDATA #IMPLIED |
| id | CDATA #REQUIRED |
| schema | CDATA #IMPLIED |

>
<!ELEMENT extension ANY>
<!ATTLIST extension

| | |
|---|---|
| point | CDATA #REQUIRED |
| id | CDATA #IMPLIED |
| name | CDATA #IMPLIED |

>

3. Plug-in Element

<!ELEMENT plugin (requires?, extension-point*, extension*)>
<!ATTLIST plugin

| | |
|---|---|
| name | CDATA #IMPLIED |
| id | CDATA #REQUIRED |
| version | CDATA #REQUIRED |
| provider-name | CDATA #IMPLIED |

>

4. Requires Element

<!ELEMENT requires (import+)>
<!ELEMENT import EMPTY>
<!ATTLIST import

| | |
|---|---|
| plugin | CDATA #REQUIRED |
| version | CDATA #IMPLIED |
| match | (exact \| compatible \| greaterOrEqual) #IMPLIED |

>

5. Import Element

<!ELEMENT requires (import+)>
<!ELEMENT import EMPTY>
<!ATTLIST import

| | |
|---|---|
| plugin | CDATA #REQUIRED |
| version | CDATA #IMPLIED |
| match | (exact \| compatible \| greaterOrEqual) #IMPLIED |

>

6. Extension-Point Element

<!ELEMENT extension-point EMPTY>
<!ATTLIST extension-point

| | |
|---|---|
| name | CDATA #IMPLIED |
| id | CDATA #REQUIRED |
| schema | CDATA #REQUIRED |

>

7. Extension-Point Element

<!ELEMENT extension ANY>
<!ATTLIST extension

| | |
|---|---|
| point | CDATA #REQUIRED |
| id | CDATA #IMPLIED |
| name | CDATA #IMPLIED |

>

What is claimed is:

1. A method for enabling an extension to an application in an J2EE platform through the use of plug-ins, the method comprising:
providing a deployment package for each of a plurality of plug-ins, the deployment package defining one or more extension points or extensions for the application and comprising a plug-in manifest file, the plug-in manifest file containing meta-data about the plug-in, interconnection data for interconnecting to one or more other plug-ins for the application, and a unique identifier for identifying the plug-in;
an extension registry service locating the plurality of plug-ins, determining interconnections between them based on the interconnection data, and maintaining associations among extension point(s) or extension(s) defined in the plug-in packages; and
invoking the located plug-ins.

2. The method according to claim 1, wherein a first plug-in provides a host role capability and the plug-in manifest file further comprises at least one extension point associated with one or more extensions.

3. The method according to claim 2, wherein a second plug-in provides an extender role capability, the method comprising:
associating the unique identifier of the extender role plug-in manifest with at least one host role plug-in; and
providing extensions to the application.

4. The method according to claim 3, wherein the extender role plug-in package provides extensions for multiple host role plug-ins.

5. The method according to claim 1, wherein the plug-in manifest file is stored in a root directory if the application in an J2EE environment is a JAR.

6. The method according to claim 1, wherein the plug-in manifest file is stored in a WEB-INF directory if the application in an J2EE environment is a WAR.

7. The method of claim 1, wherein the extension registry service locates plug-ins as J2EE modules are loaded.

8. The method of claim 1, wherein the extension registry services maintains associations between plug-in packages in a datastore.

9. The method of claim 8, wherein the extension registry service detects when J2EE modules are unloaded and updates the associations in the datastore based on such detection.

10. A computer program product comprising computer readable medium storing thereon computer code for causing a computer to execute a method enabling an extension to an application in an J2EE platform through the use of plug-ins, the method comprising:
providing a deployment package for each or a plurality of plug-ins, the deployment package defining one or more extension points or extensions for the application and comprising a plug-in manifest file, the plug-in manifest file containing meta-data about the application, interconnection data for interconnecting to one or more other plug-ins for the application, and a unique identifier for identifying the plug-in;
an extension registry service locating the plurality of plug-ins, determining interconnections between them based on the interconnection data, and maintaining associations among extension point(s) or extension(s) defined in the plug-in packages; and
invoking the located plug-ins.

11. A computerized method of providing extensions to an application in an J2EE environment through the use of plug-in packages and an extension registry service, wherein the plug-in packages each comprise a plug-in manifest file containing meta-data about the plug-in, interconnection data for interconnecting to one or more other plug-ins for the application, and a unique identifier for identifying the plug-in, the method comprising:
locating and collecting plug-in packages;
associating, through the use of the unique identifiers and the interconnection data, one or more extensions in a first plug-in with one or more extension points in one or more second plug-ins; and
executing the associated one or more extensions in the application.
